(19) United States
(12) Patent Application Publication
(10) Pub. No.: US 2008/0024261 A1
(43) Pub. Date: Jan. 31, 2008

(54) High Voltage Transformer

(76) Inventors: Hiroshi Shinmen, Kitasaku-gun (JP); Mitsuaki Suzuki, Kitasaku-gun (JP); Robert Weger, Wels (AT)

Correspondence Address: OLIFF & BERRIDGE, PLC, P.O. BOX 320850, ALEXANDRIA, VA, 22320-4850, US

(21) Appl. No.: 11/664,820

(22) PCT Filed: Nov. 7, 2005
(86) PCT No.: PCT/JP05/20363

§ 371 Date: Apr. 6, 2007

(30) Foreign Application Priority Data
Nov. 19, 2004 (JP) 2004-336552

(51) Int. Cl. H01F 27/30

(52) U.S. Cl. 336/208

(57) ABSTRACT

A high voltage transformer is provided in which a primary winding is located selectively and optimally with respect to a secondary winding, and so the primary winding is allowed to be tightly coupled electromagnetically to the secondary winding, while the workability in assembly is improved. In the high voltage transformer, a primary winding (8) and a secondary winding (6) are wound around a spool body (3) of a bobbin (1), and a magnetic core made of magnetic material is inserted in the hollow of the bobbin (1). The bobbin (1) includes terminal blocks (2a and 2b) disposed at the both ends of the spool body (3) and provided with a plurality of terminals (5a to 5g), the secondary winding (6) is wound on the outer circumferential surface of the spool body (3), and the primary winding (8) which is constituted by thin conductive sheet coils coated with resin is disposed around the secondary winding (6). A means for fixedly positioning the thin conductive coil sheet constituting the primary winding (8) is formed at the outer circumference of the bobbin (1) or at a board for attaching the bobbin, and the primary winding (8) can be disposed selectively by the positioning means around the secondary winding (6) at the arbitrary and optimal locations thereby modulating the electromagnetic coupling between the primary winding (8) and the secondary winding (6).

### BACKGROUND OF THE INVENTION

1. Field of the Invention

The present invention relates to a high voltage transformer, and particularly to a high voltage transformer for lighting a discharge lamp for use in a liquid crystal display device, and the like.

2. Description of the Related Art

A discharge lamp, such as a cold cathode lamp and a metal halide lamp, has been used as a light source for a backlight device for a liquid crystal display (LCD) device, a facsimile machine, a copy machine, and like devices. A high voltage is required for lighting such a discharge lamp, and a cold cathode lamp, for example, is lit by an output of an oscillation circuit boosted up to several kV by using a high voltage transformer. Such a high voltage transformer is disclosed in, for example, Japanese Patent Application Laid-Open No. H8-153634. The high voltage transformer disclosed therein includes a magnetic core made of ferrite and inserted in a bobbin which has its spool area divided by flanges into a plurality of sections arrayed along the length of the bobbin, and around which electrical conductive wires are wound thereby constituting primary and secondary windings. When a large current is to flow in the windings, the wires are required to have a large diameter. So, if the primary winding is to carry a large current, then the wire of the primary winding must have a large diameter, thus increasing the dimension of the transformer.

To overcome the above-described dimensional increase issue of a high voltage transformer, for example, Japanese Patent Application Laid-Open No. H10-241972 discloses a high voltage transformer for lighting a discharge lamp, in which a sheet coil made of a thin conductive metal tape is used for the primary winding, whereby a large current is allowed to flow in the primary winding while successfully achieving downsizing. FIG. 13 is an exploded perspective view of such a high voltage transformer as disclosed in the aforementioned Japanese Patent Application Laid-Open No. H10-241972. In the high voltage transformer of FIG. 13, a closed magnetic path is constituted by a U-core 100 and an I-core 100a, and primary windings 101 and 101a are each constituted by a sheet coil of a thin conductive metal tape formed into squared-U shape. The primary winding 101 has its respective leg portions of the squared-U inserted through openings 105a and 105b formed at a flange 104 of a bobbin, and the primary winding 101a has its respective leg portions inserted through openings 105c and 105d formed at a flange 104a of another bobbin. Secondary windings 102 and 102a each include two tiers of single-layer alignment windings so that the electric capacity is increased while the insulation between adjacent wires is enhanced and at the same time the potential difference between adjacent wires is reduced, whereby a short circuit attributable to the potential difference is decreased. Also, since the magnetic circuit has a closed magnetic path, the high voltage transformer can be downsized.

In the high voltage transformer of FIG. 13, the primary winding is capable of carrying a large current, but because the primary winding and the secondary winding are disposed in a tandem arrangement along the same axis, there is provided a poor electromagnetic coupling therebetween. Accordingly, the high voltage transformer of FIG. 13, when adapted as a transformer with a high coupling between the primary and secondary windings, namely a tightly-coupled transformer, is caused to behave with deteriorated performance. Also, the sheet coil constituting the primary winding and inserted in the opening of the bobbin must be coated with a thick resin in order to secure insulation, which deteriorates the workability.

### SUMMARY OF THE INVENTION

The present invention has been made in light of the problems described above, and it is an object of the present invention to provide a high voltage transformer in which a primary winding can be positioned selectively and optimally with respect to a secondary winding, and so the primary winding is allowed to be tightly coupled electromagnetically to the secondary winding, while the workability in assembly is improved.

In order to achieve the object described above, according to an aspect of the present invention, a high voltage transformer is provided which includes: a bobbin including a spool body with a hollow; a magnetic core formed of magnetic material and disposed at the hollow of the bobbin; and a primary winding and a secondary winding both disposed around the spool body of the bobbin. In the high voltage transformer described above, the bobbin further includes terminal blocks which are disposed respectively at the both ends of the spool body and which each have a plurality of terminals; the spool body is split into a plurality of sections by a plurality of flanges; the primary winding is composed of at least one thin conductive sheet coil coated with resin by insert molding; and the secondary winding is split into a plurality of separate windings disposed respectively at the sections of the spool body, wherein the primary winding can be disposed around the secondary winding selectively at any one of the separate windings of the secondary winding by a positioning means which is constituted by the primary winding engaging with the plurality of flanges.

In the aspect of the present invention, the thin conductive sheet coil which constitutes the primary winding and is coated with resin by insert molding may have a width substantially identical with the width of each separate winding of the primary winding.

In the aspect of the present invention, the positioning means may be constituted such that recesses formed at the thin conductive sheet coil of the primary winding are engaged with projections provided at the plurality of flanges.

In the aspect of the present invention, the primary winding may be composed of one or two thin conductive sheet coils having a configuration identical with each other, and a boss for positioning the bobbin onto the board may be provided at the bottom of each of the terminal blocks of the bobbin.

And, in the aspect of the present invention, the spool body may have an indented portion provided at an area corresponding to the position of the primary winding, and the secondary winding may have an outer diameter smaller at a portion corresponding to the intended portion than at the other portion clear of the primary winding.

Accordingly, since the primary winding and the secondary winding can be disposed close to each other on the same axis, the electromagnetic coupling between the primary and secondary windings is enhanced, which improves the efficiency of the transformer. Also, since the primary winding is composed of thin conductive sheet coils coated with resin, the insulation from the secondary winding is ensured, the assembling workability is enhanced, and the number and arrangement of the coils can be arbitrarily and optimally selected allowing the coupling coefficient of the transformer to be adjusted. Consequently, the transformer characteristics and the component standardization can be achieved.

### BRIEF DESCRIPTION OF THE DRAWINGS

FIG. 1 is a plan view of a high voltage transformer according to an embodiment of the present invention, showing a bobbin and primary and secondary windings disposed around the bobbin (magnetic cores omitted);

FIG. 2 is a cross sectional view of the high voltage transformer of FIG. 1 taken along line A-A, together with a magnification of a relevant portion A (circled);

FIG. 3 is a right side view of the high voltage transformer of FIG. 1;

FIG. 4 is an explanatory perspective view of how sheet coils of the primary winding are to be put on the bobbin;

FIG. 5 is an explanatory bottom view of how magnetic cores are to be set in the bobbin;

FIGS. 6(a), 6(b) and 6(c) are cross sectional views of common examples of primary windings incorporated in the high voltage transformer according to the present invention;

FIG. 7(a) is a schematic view of magnetic cores set in one bobbin, and FIG. 7(b) is a schematic view of magnetic cores set in two bobbins;

FIG. 8 is a schematic view of a printed circuit board, showing holes for mounting the high voltage transformer according to the present invention;

FIG. 9(a) is a schematic cross sectional view of a winding portion having a plain floor with no intermediate flanges, and FIG. 9(b) is a schematic cross sectional view of a winding portion having a stepped floor with no intermediate flanges;

FIG. 10 is a perspective view of a modification of the primary winding;

FIG. 11 is a cross sectional view of a high voltage transformer with a primary winding disposed around a bobbin having sections of two different widths;

FIG. 12 is a cross sectional view of a high voltage transformer with a primary winding having its outermost plane aligned with an outermost plane of the bobbin; and

FIG. 13 is an exploded perspective view of a conventional high voltage transformer.

### DETAILED DESCRIPTION OF THE INVENTION

An exemplary embodiment of the present invention will hereinafter be described with reference to the accompanying drawings.

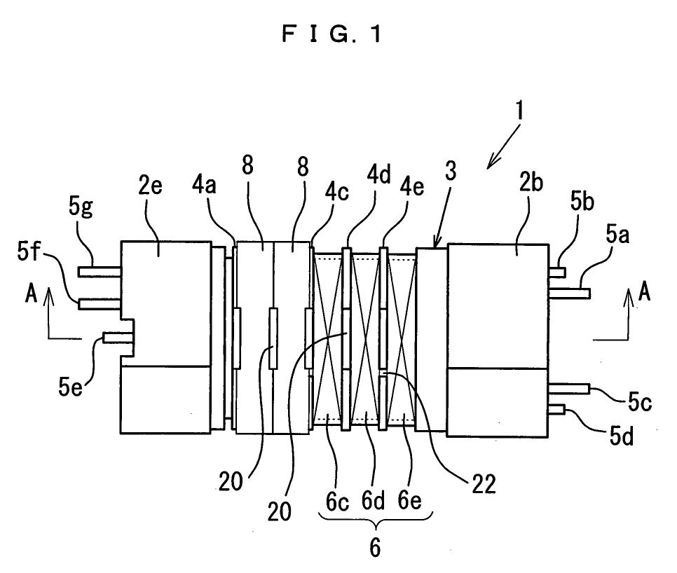

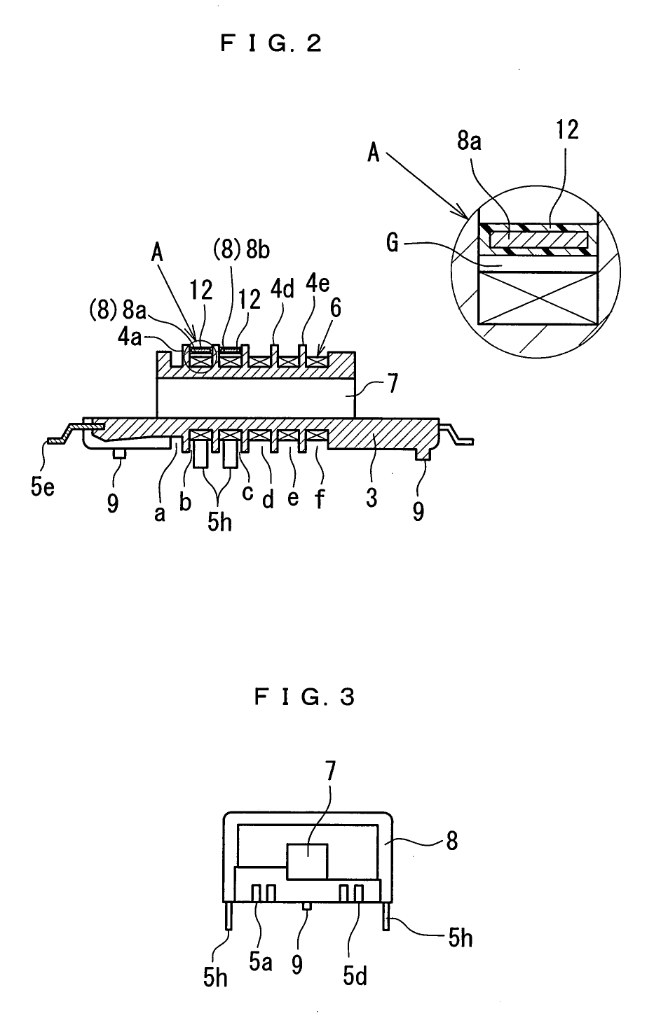

Referring to FIGS. 1 and 2, a high voltage transformer according to an embodiment of the present invention includes a bobbin 1 which is formed of resin, such as liquid crystal polymer (LCP), and which integrally includes a spool body 3 and two terminal blocks 2a and 2b located at the respective ends of the spool body 3, and one terminal block 2a thereof is provided with terminals 5a, 5b, 5c and 5d while the other terminal block 2b is provided with terminals 5e, 5g and 5f.

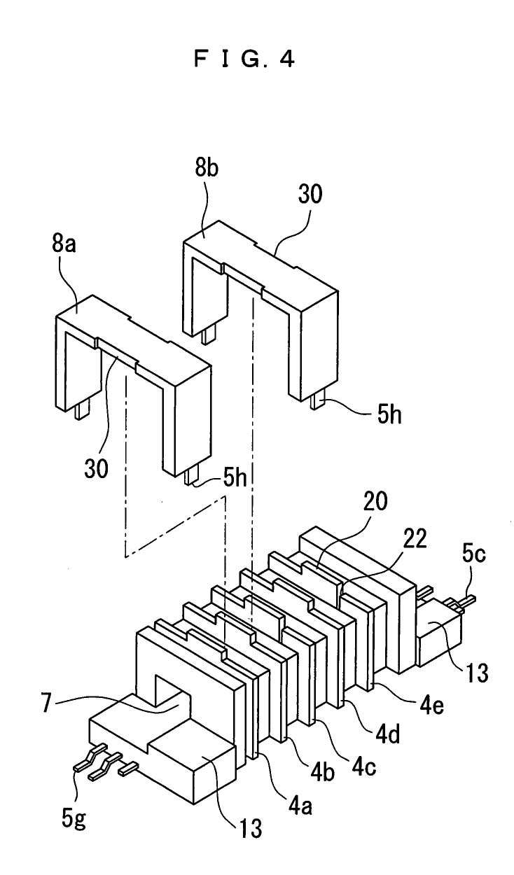

The spool body 3 is partitioned by a plurality of flanges 4a to 4e into a plurality (six in FIGS. 1 and 2) of sections a to f disposed along the axial direction, and has a primary winding 8 and a secondary winding 6 disposed therearound as shown in FIG. 2. Referring to FIG. 2, each of the flanges 4a to 4e has a projection 20 at its top side (upper side in FIG. 4), and has a slit groove 22 at either its top or bottom side (not necessarily on the flange 4a) for enabling the secondary winding 6 to be put into a split structure with separate windings 6a, 6b, 6c, 6d and 6e which are disposed at the sections b, c, d, e and f, respectively. The sections b to f of the spool body 3 have a uniform width so that the separate windings 6a to 6e have substantially the same voltage. In FIGS. 1 and 2, the terminals 5a, 5b, 5c and 5d are for the secondary winding 6, and the terminal 5e is for ground (GND). No winding is provided at the section a in the embodiment, but a tertiary winding, for example, feedback winding, may be disposed at the section a, in which case the terminals 5f and 5g are available for use with the tertiary winding. The spool body 3 has a hollow 7, and the terminal blocks 2a and 2b each have a boss 9 at the bottom as shown in FIGS. 2 and 3.

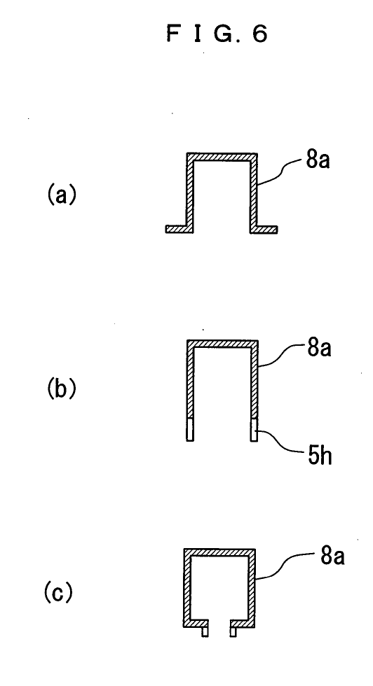

Referring to FIG. 2, the primary winding 8 arranged overlappingly around part of the secondary winding 6 is basically composed of two sheet coils 8a and 8b, which are coated with a resin 12 as shown in a magnified view of a portion A (circled) for ensuring insulation between the primary winding 8 and the secondary winding 6. The sheet coil 8a/8b is a pressed part with a configuration of squared-U and has two terminal portions 5h integrally extending from the respective leg tips of the squared-U. The sheet coil 8a/8b, except the terminal portions 5h, is coated with the resin 12 having a thickness of about 0.5 mm by insert molding. FIGS. 6(a), 6(b) and 6(c) show examples of common configurations of sheet coils. In the present embodiment, the sheet coil 8a/8b of the primary winding 8 is configured as shown in FIG. 6(b), and both of the sheet coils 8a and 8b are arranged at the low voltage side of the secondary winding 6. The sheet coils 8a and 8b each have two recesses 30 (refer to FIG. 4) formed at both sides of the bridge portion of the squared-U, which engagingly fit to the projections 20 of the flanges 4a, 4b and 4c while the unrecessed areas of the both sides of the bridge portions of the sheet coils 8a and 8b are adapted to sit on the upper sides of the flanges 4a, 4b and 4c so that the primary winding 8 encloses the separate windings 6a and 6b of the secondary winding 6 with a clearance gap G of about 0.5 mm (refer to the magnified view in FIG. 2) provided therebetween.

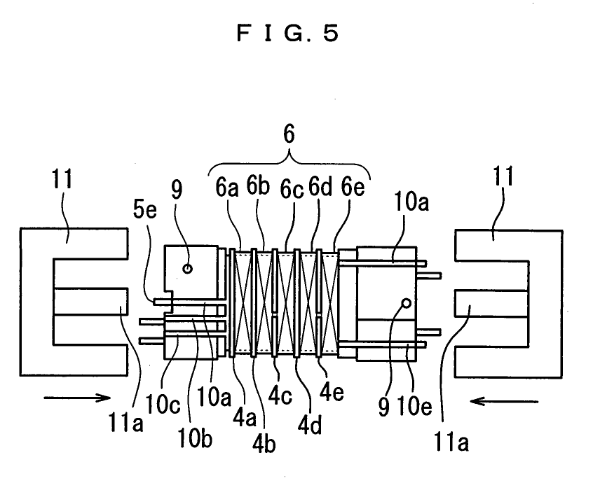

Referring to FIG. 4 showing an example bobbin according to the present invention, the terminal blocks 2a and 2b of the bobbin 1 each have an elevated portion 13, which serves as a guide to allow an easy insertion of a magnetic core 11 (refer to FIG. 5) into the hollow 7 of the bobbin 1. Referring to FIG. 5, on the bottom face of the bobbin 1, grooves 10b and 10c are provided for accommodating lead wires of the tertiary winding (if provided), grooves 10d and 10e are provided for lead wires of the secondary winding 6, and a groove 10a is for a wire leading to the terminal 5e for GND.

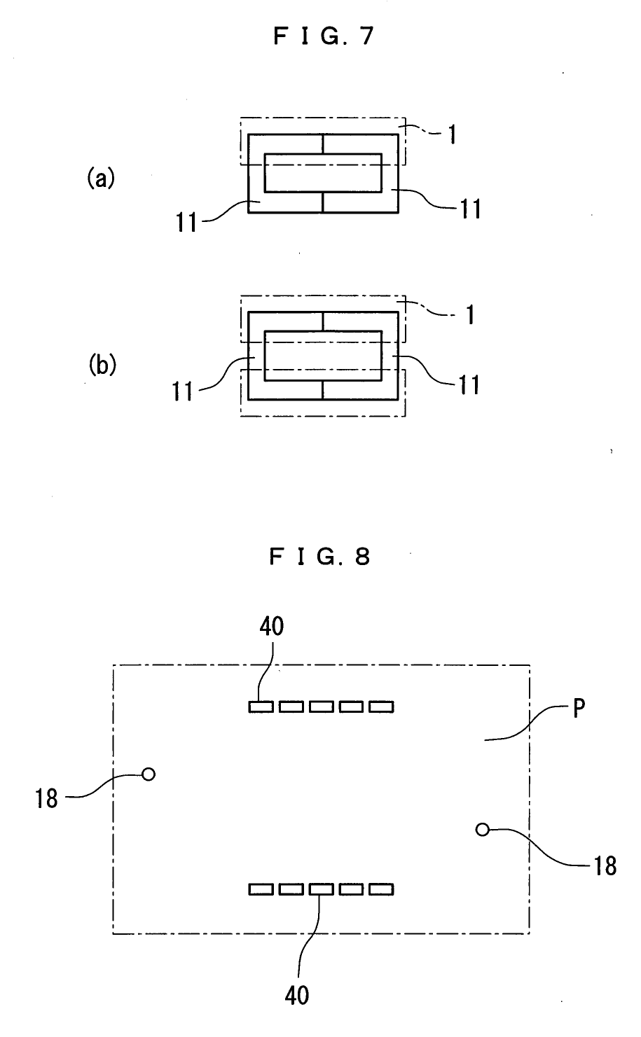

The aforementioned magnetic cores 11 are made of ferrite and are both constituted by E-cores in the embodiment shown in FIG. 5, which have their respective center legs 11a inserted in the hollow 7 of the bobbin 1 and fixedly attached to each other by adhesive. The magnetic cores 11 do not have to be constituted by two E-cores, and may alternatively be constituted by, for example, one E-core and one I-core, or two U-cores. For example, two U-cores 11 may have their respective one legs inserted in one bobbin 1 as shown in FIG. 7(a) and adhesively connected to each other, or two U-cores 11 may have their respective both legs inserted respectively in two bobbins 1 as shown in FIG. 7(b) and adhesively connected to each other.

The five flanges 4a to 4e of the bobbin 1, which are sized to the outside dimension of the bobbin 1, together with their respective projections 20 provided at the top sides of the flanges 4a to 4e, function as a positioning means. This positioning means allows the primary winding 8 constituted by one or two of the sheet coils 8a and 8b to be fixedly set at sections predetermined at either the low voltage side or the high voltage side of the secondary winding 6 according to the transformer characteristics intended.

The bobbin 1, with the cores 11 fitted therein, is fixedly attached to a printed circuit board of a backlight inverter circuit, and the like, and the terminals of the bobbin 1 are soldered to the printed circuit board. In the present invention, the bosses 9 formed at the bottom faces of the terminal blocks 2a and 2b are fitted into respective holes 18 formed at a printed circuit board P (refer to FIG. 8), whereby the bobbin 1 can be readily attached at the right place on the printed circuit board P.

Thus, the separate windings 6a to 6e of the secondary winding 6 are wound respectively at the sections b to f of the spool body 3 of the bobbin 1, the center legs 11a of the E-cores 11 are inserted in the hollow 7 of the spool body 3 (refer to FIG. 3) for assembly, and then the primary winding 8 is set at the predetermined sections when the bobbin 1 is attached to the printed circuit board.

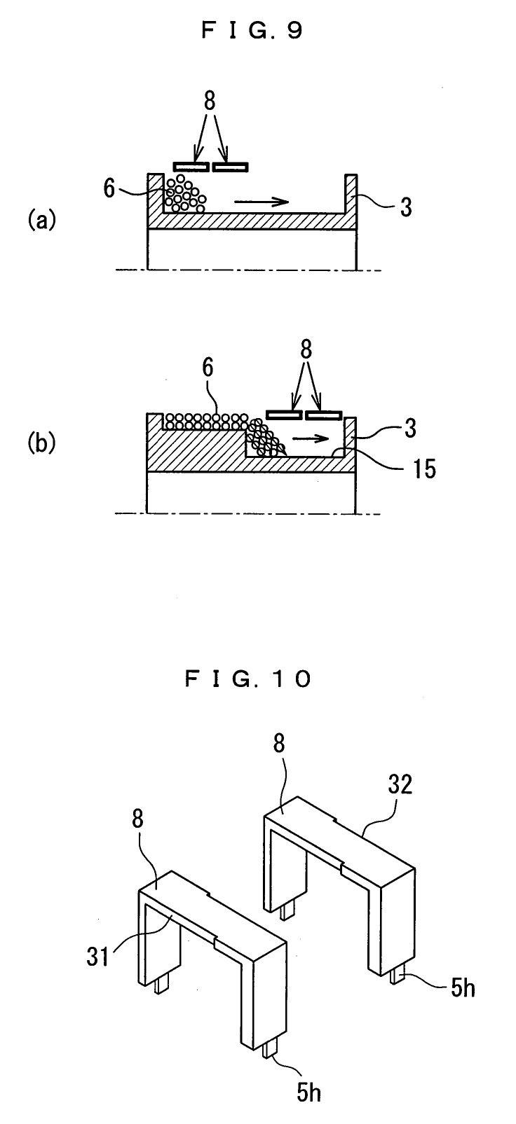

All the sections a to f are uniform in depth as shown in FIG. 2, but it may alternatively be arranged such that sections at which the primary winding is located are deeper than the other sections. Specifically, referring to FIG. 9(b), an indented portion 15 is provided at an area of a spool body 3 having a primary winding 8 therearound, and a secondary winding 6 is wound such that the outer diameter at a portion thereof having the primary winding 8 therearound is smaller than the outer diameter at the other portion thereof. Accordingly, the primary winding 8 has its radial dimension reduced so as to be aligned with the radial dimension of the secondary winding 6, whereby the primary winding 8 does not protrude beyond the diameter of a bobbin.

The primary winding 8 is duly positioned with respect to the secondary winding 6 by means of the flanges 4a to 4e and the projections 20 formed at the top sides of the flanges 4a to 4e in the embodiment, but may be positioned by other methods or means. For example, a plurality of holes 40 formed at the printed circuit board P as shown in FIG. 8 are an alternative means, wherein the sheet coil 8a of the primary winding 8 is set around the section b having the separate winding 6a of the secondary winding 6, and the terminal portions 5h are inserted through the holes 40 formed at the wiring pattern on the printed circuit board P, whereby the primary winding 8 (8a) is provided around the secondary winding 6 (6a) while duly mounted on the printed circuit board P. If the holes 40 are formed at locations corresponding to all the sections b to f, the primary winding 8 can be set at any sections thereby readily and optimally modulating the transformer characteristics. The primary winding 8 may be composed of one or a plurality of sheet coils located at desired places around the secondary winding 6.

The sheet coil for the primary winding 8 is coated with resin thereby ensuring insulation. Also, the primary winding 8 can be composed of sheet coils which have the same configuration, and which therefore can be produced as common parts. The terminal portions 5h of the sheet coil 8a/8b extend straight as shown in FIG. 6(b) and are inserted though the holes 40 formed at the wiring pattern of the printed circuit board P in the embodiment, but may alternatively be bent as shown in FIG. 6(a) so as to make contact with the wiring pattern.

In the present embodiment, the plurality of sections a to f are formed at the spool body 3 of the bobbin 1, but the present invention is not limited to such a structure, and the bobbin 1 may have a single section as shown in FIGS. 9(a) and 9(b) at the spool body 3, where at least the high voltage side of the secondary winding 6 is constituted by a diagonally overlapped winding in order to ensure a sufficient withstand voltage. Also, as described earlier, the single section may have the indented portion 15 at an area having the primary winding 8 around as shown in FIG. 9(b), whereby the primary winding 8 can be downsized so as to have an outside diameter equal to the outside diameter of the secondary winding 6 defined at an area at which the primary winding 8 is absent, thus enabling downsizing of the high voltage transformer.

Further, the sheet coil 8a/8b of the primary winding 8 of the embodiment is provided with the two recesses 30 located at respective middle regions of the both sides of the bridge portion of the squared-U structure so as to directly oppose each other as shown in FIG. 4, but the bridge portion of the sheet coil of the primary winding 8 may alternatively have two recesses 31 and 32 which are arranged at respective sides of the bridge portion so as to diagonally oppose each other as shown in FIG. 10. And, the projection 20, which is provided at the top side of the flange 4 in the embodiment, may be located at a lateral side of the flange 4, or alternatively the flange 4 may be replaced by a plurality of pins for positioning the primary winding 8.

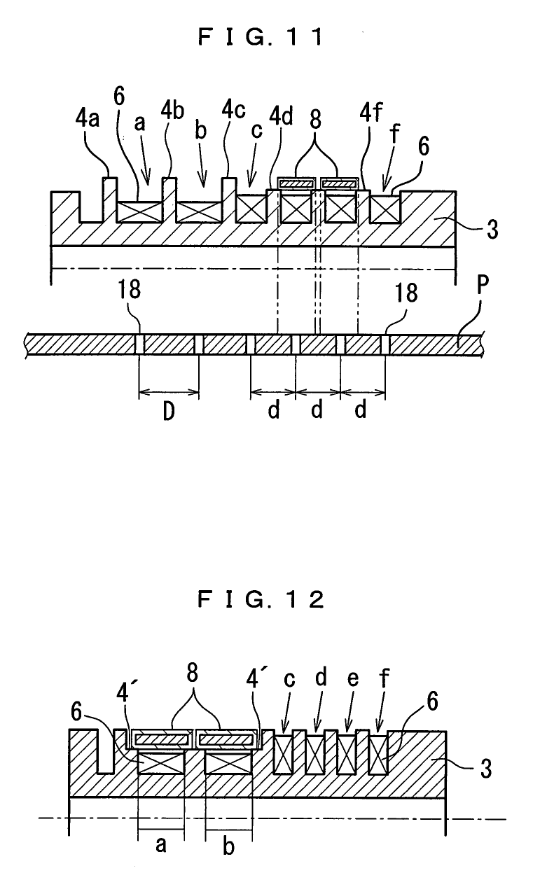

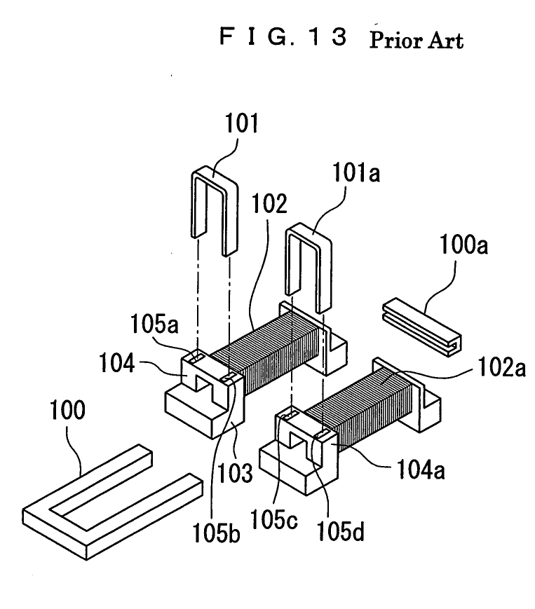

The sections b to f of the spool body 3 having the secondary winding 6 thereat have a uniform width in the embodiment, but may alternatively have different widths. For example, referring to FIG. 11, a spool body 3 has six sections a to f having a secondary winding 6, wherein the sections c to f positioned at the high voltage side of the secondary winding 6 have a reduced width compared with the sections a and b positioned at the low voltage side of the secondary winding 6, whereby the high voltage side can be provided with an increased number of sections thus splitting the secondary winding 6 into an increased number of separate windings at the high voltage side. In this case, the sheet coil of the primary winding 8 may have its configuration changed to the geometry of the sections corresponding thereto, or may be disposed atop the flanges 4e and 4f, wherein the sheet coil of the primary winding 8 can be optimally positioned around the secondary winding 6 by means of terminal pin holes 18 formed at the printed circuit board P at an interval d which is smaller than an interval D defined at the low voltage side of the secondary winding 6.

Thus, the primary winding 8 can be positioned by means of projections and recesses which are formed at the flanges 4a to 4f of the bobbin 1 and at the sheet coil of the primary winding 8, or vice versa, or alternatively by a plurality of holes which are formed at arbitrary places of the printed circuit board P.

Also, referring to FIG. 12, sections a and b have their width increased and are provided with a step 4′, whereby the secondary winding 6 can be structured so as to have its radial dimension reduced at the low voltage side thus enabling the primary winding 8 to be firmly disposed substantially flush with the flanges of the bobbin 1 while the total turn number of the secondary winding 6 remains unchanged.

With the structure described above, even if the primary winding 8 is placed around the secondary winding 6 in order to increase coupling intensity therebetween, the primary winding 8 can be disposed flush with the outer dimension of the bobbin 1, whereby the height of the high voltage transformer mounted on the printed circuit board can be minimized.

1. A high voltage transformer comprising:
a bobbin comprising a spool body which has a hollow and is split into a plurality of sections by a plurality of flanges, and terminal blocks which are disposed respectively at both ends of the spool body and which each have a plurality of terminals;
a magnetic core formed of magnetic material and disposed at the hollow of the bobbin;
a primary winding disposed around the spool body of the bobbin and composed of at least one thin conductive sheet coil coated with resin by insert molding;
a secondary winding disposed around the spool body and split into a plurality of separate windings disposed respectively at the sections of the spool body; and
a positioning means which is constituted by the primary winding engaging with the plurality of flanges, and by which the primary winding can be disposed around the secondary winding selectively at any one of the separate windings of the secondary winding.

2. A high voltage transformer according to claim 1, wherein the primary winding comprises either one thin conductive sheet coil, or two thin conductive sheet coils having a configuration identical with each other.

3. A high voltage transformer according to claim 1, wherein the thin conductive sheet coil constituting the primary winding has a width substantially identical with a width of each separate winding.

4. A high voltage transformer according to claim 1, wherein the positioning means is constituted such that recesses formed at the thin conductive sheet coil of the primary winding are engaged with projections provided at the plurality of flanges.

5. A high voltage transformer according to claim 1, the primary winding is disposed at a low voltage side of the secondary winding.

6. A high voltage transformer according to claim 1, wherein a boss for positioning the bobbin onto the board is provided at a bottom of each of the terminal blocks of the bobbin.

7. A high voltage transformer according to claim 1, wherein the spool body has an indented portion provided at an area corresponding to a position of the primary winding, and the secondary winding has an outer diameter smaller at a portion corresponding to the intended portion than at the other portion clear of the primary winding.

8. (canceled)
